(19) United States
(12) Patent Application Publication
(10) Pub. No.: US 2018/0003150 A1
(43) Pub. Date: Jan. 4, 2018

(54) ENERGY HARVESTING WATER VEHICLE

(71) Applicant: King Abdullah University of Science and Technology, Thuwal (SA)

(72) Inventor: Devendra Singh, Thuwal (SA)

(21) Appl. No.: 15/635,408

(22) Filed: Jun. 28, 2017

Related U.S. Application Data
(60) Provisional application No. 62/356,743, filed on Jun. 30, 2016.

(51) Int. Cl. F03B 17/06; B63B 35/44; H02K 7/18

(52) U.S. Cl. CPC F03B 17/062; H02K 7/1823; B63B 35/44; B63B 2035/4466; F05B 2240/931; F05B 2220/706

(57) ABSTRACT

An efficient energy harvesting (EEH) water vehicle is disclosed. The base of the EEH water vehicle is fabricated with rolling cylindrical drums that can rotate freely in the same direction of the water medium. The drums reduce the drag at the vehicle-water interface. This reduction in drag corresponds to an increase in speed and/or greater fuel efficiency. The mechanical energy of the rolling cylindrical drums is also transformed into electrical energy using an electricity producing device, such as a dynamo or an alternator. Thus, the efficiency of the vehicle is enhanced in two parallel modes: from the reduction in drag at the vehicle-water interface, and from capturing power from the rotational motion of the drums.

### CROSS-REFERENCE TO RELATED APPLICATION

This application claims priority to U.S. Provisional Application No. 62/356,743, filed on Jun. 30, 2016. The aforementioned application is herein incorporated by reference in its entirety.

### FIELD OF TECHNOLOGY

The present invention relates to the technical field of energy capture devices. In particular, the present invention relates to water vehicles having the ability to harvest energy from the surrounding environment and/or the motion of the vehicle.

### BACKGROUND OF THE INVENTION

Much of the energy used to power vehicles does not go towards moving the vehicle forward, but is instead dissipated to the surrounding environment. For example, the friction from car tires leads to the energy produced by the engine ending up as heat dissipated to the road or surrounding air. For water vehicles or watercraft, such as sailboats and powerboats, energy dissipation to the environment can be especially great due to the resistance from the water. For sailboats, where weight is often an important consideration, electric power can be limited because of the lack of a high energy output motor to drive an alternator, the lack of efficiency and size limitations of solar panels, and the weight and capacity limits of batteries.

During a sailing, such as a one day cruise, electricity consumption has to be carefully managed. Electric devices, such as any refrigerators, radios, or audio systems, might be switched off to conserve battery charge. See G. L. Guizzi and M. Manno, Proceedings of ECOS 2012—The 25th International Conference on Efficiency, Cost, Optimization, Simulation, and Environmental Impact of Energy Systems, Jun. 26-29, 2012, Perugia, Italy. For sailboats that do have an onboard generator, it may be necessary to recharge the batteries with it, which causes noise, smoke, and pollution lasting for up to a few hours. For recreational sailings, the generator's shortcomings can be particularly problematic for the enjoyment of the experience.

Therefore, what is needed is an apparatus, system, and method to provide efficient energy harvesting for water vehicles.

### SUMMARY OF INVENTION

In an aspect, an efficient energy harvesting (EEH) water vehicle is disclosed. In one embodiment, the base of the EEH water vehicle is fabricated with rotational/rolling cylindrical drums that can rotate freely in the same direction of the water medium while reducing the drag between the vehicle-water interface. The shape of the drums is not limited to be cylindrical. The drums may be spherical, pedal-type, or any other appropriate shape. The geometry may be optimized for greater efficiency. Consequently, when the vehicle is in motion, a reduction in drag will correspond to an increase of speed of the vehicle. This reduced drag and higher speeds can lead to greater efficiency in traveling between two points. In addition, the mechanical energy of the rolling cylindrical drums can be transformed into electrical energy using an electricity producing device, such as a dynamo.

In a further aspect, the efficiency of the vehicle is enhanced in two parallel modes. First, the invention, in embodiments, reduces the drag of vehicle at the vehicle-water interface. Second, the invention, in embodiments, generates power from the rotational motion of the connected drums/cylinders.

The disclosed EEH water vehicles can be used in the following aspects: high speed water vehicles due to reduction in drag at the vehicle-water interface; fuel efficient vehicles; and for electrical energy generation from the rotating cylindrical drums.

In an embodiment, the drums/cylinders are deployable and are in contact with water when in use. When not in use, the drums/cylinders are withdrawn into the hull of the vehicle and out of contact with the water. In still another embodiment, the rotation of the drums/cylinders is caused by water currents, allowing for the generation of power when the vehicle is being pushed by the natural motion of the water. In still another embodiment, the rotation of the drums/cylinders occurs only when the vehicle's propulsion system is not running.

Numerous other embodiments are described throughout herein. All of these embodiments are intended to be within the scope of the invention herein disclosed. Although various embodiments are described herein, it is to be understood that not necessarily all objects, advantages, features, or concepts need to be achieved in accordance with any particular embodiment. Thus, for example, those skilled in the art will recognize that the invention may be embodied or carried out in a manner that achieves or optimizes one advantage or group of advantages as taught or suggested herein without necessarily achieving other objects or advantages as may be taught or suggested herein.

The methods and systems disclosed herein may be implemented in any means for achieving various aspects. These and other features, aspects, and advantages of the present invention will become readily apparent to those skilled in the art and understood with reference to the following description, appended claims, and accompanying figures, the invention not being limited to any particular disclosed embodiment(s).

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and the invention may admit to other equally effective embodiments.

FIG. 1A illustrates a lateral view of an efficient energy harvesting boat with cylindrical drums, according to an embodiment.

FIG. 1B illustrates a side view of an efficient energy harvesting boat, according to an embodiment.

FIG. 1C illustrates a bottom view of an efficient energy harvesting boat, according to an embodiment.

FIG. 1D illustrates a lateral view of an efficient energy harvesting boat with cylindrical drums and a chined hull, according to an embodiment.

FIG. 1E illustrates a side view of an efficient energy harvesting boat with cylindrical drums and a chined hull, according to an embodiment.

FIG. 1F illustrates a bottom view of an efficient energy harvesting boat with cylindrical drums and a chined hull, according to an embodiment.

FIG. 2 illustrates a schematic diagram of an exemplary system for transforming rotational energy into electrical energy, according to an embodiment.

Other features of the present embodiments will be apparent from the Detailed Description that follows.

### DETAILED DESCRIPTION OF THE EMBODIMENTS

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention. Electrical, mechanical, logical and structural changes may be made to the embodiments without departing from the spirit and scope of the present teachings. The following detailed description is therefore not to be taken in a limiting sense, and the scope of the present disclosure is defined by the appended claims and their equivalents.

The use of the terms “a,” “an,” “the,” and similar referents in the context of describing the presently claimed invention (especially in the context of the claims) are to be construed to cover both the singular and the plural, unless other-wise indicated herein or clearly contradicted by context.

Recitation of ranges of values herein are merely intended to serve as a shorthand method of referring individually to each separate value falling within the range, unless otherwise indicated herein, and each separate value is incorporated into the specification as if it were individually recited herein.

Use of the term “about” is intended to describe values either above or below the stated value in a range of approximately +/−10%; in other embodiments the values may range in value either above or below the stated value in a range of approximately +/−5%; in other embodiments the values may range in value either above or below the stated value in a range of approximately +/−2%; in other embodiments the values may range in value either above or below the stated value in a range of approximately +/−1%. The preceding ranges are intended to be made clear by context, and no further limitation is implied. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

The term “water vehicle” or “watercraft” refers to a boat, row boat, sailboat, ship, cruise ship, tugboat, warship, battleship, aircraft carrier, submarine, or any other vehicle that is buoyant and transports passengers, cargo, or both. The water vehicle can be powered by a motor, wind, or rowing to propel the water vehicle in a desired direction.

The term “alternator” refers to a device that makes alternating current electric power using electromagnetism. The term “dynamo” refers to a device that makes direct current electric power using electromagnetism. The term “rotary converter” refers to a device that is a mechanical rectifier, inverter, or frequency converter. The term “generator” refers to a device that converts mechanical energy obtained from an external source into electrical energy as the output.

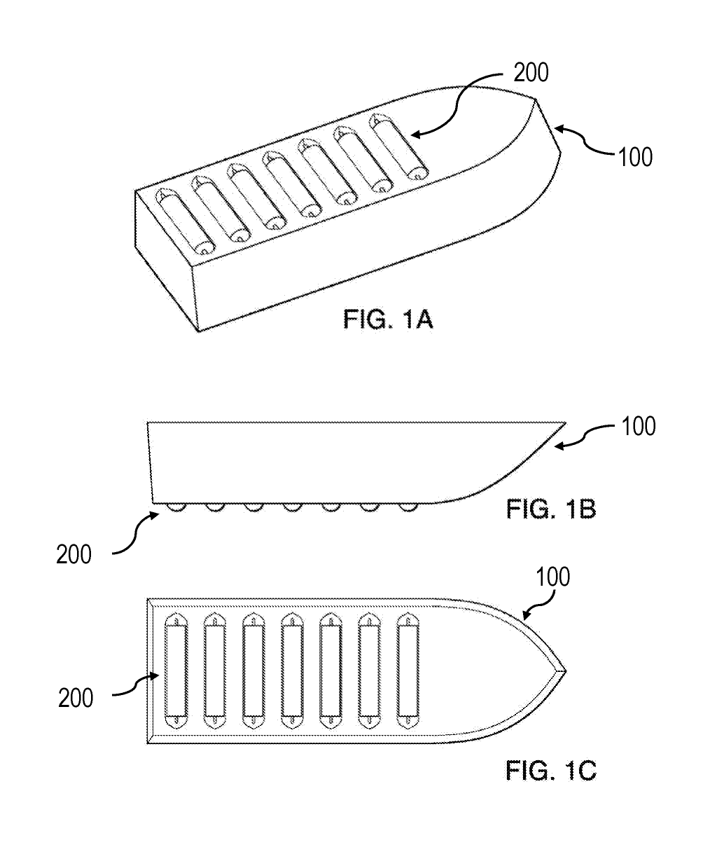

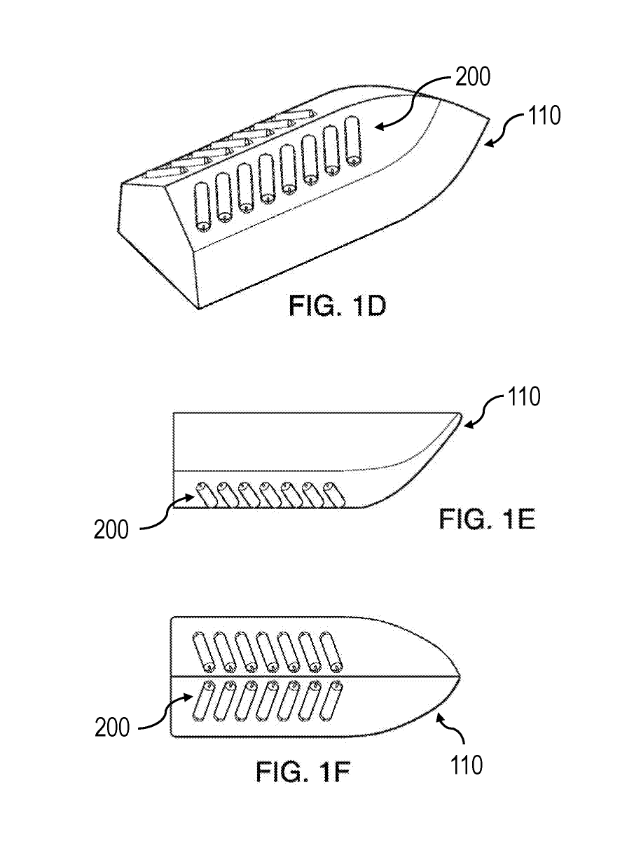

FIGS. 1A-F illustrates exemplary embodiments of efficient energy harvesting (EEH) water vehicles. FIG. 1A shows a perspective side view of an exemplary embodiment of an EEH water vehicle. EEH vehicle has rotating drums/cylinders 200 rotationally attached to the hull 100. In FIG. 1A, EEH vehicle is moving from the left to the right using propulsion system. Drums/cylinders 200 will rotate in a clockwise manner in this embodiment.

The disclosed EEH vehicles are typically buoyant, water or marine vehicles. Hulls 101, 102 can be fabricated out of materials customarily used to fabricate the hulls of marine vehicles. Exemplary materials that can be used to fabricate hulls 100, 110 include but are not limited to wood such as teak, totara, cedar, oak, and plywood. Wood hulls are typically coated with a waterproof polymer. Other materials used to make hulls 100, 110 include steel, aluminum, fiberglass, composite material, and steel reinforced cement.

The hull of the disclosed EEH vehicles can be a smooth curve hull, a chined or hard chined hull, a flat bottom hull, a displacement hull, or a planing hull. EEH vehicle 100 is an exemplary flat bottom hull vehicle. EEH vehicle 110 is an exemplary hard chined hull vehicle.

Rotating drums/cylinders 200 can be made of the same or different material than hulls 100, 110. In a preferred embodiment, drums/cylinders 200 are made of fiberglass, polymeric material, metal or metal alloy. The drums/cylinders may be coated with an anti-fouling material to prevent or slow biofouling. The anti-fouling material may comprise biocides, such as tributyltin moiety, incorporated into the surface or coating, other tin-based materials, chlorine based materials or solutions, or a material that is toxic to aquatic organisms.

Drums/cylinders 200 are rotationally coupled to or attached to hulls 100, 110. The number of drums/cylinders 200 can vary in number from 1, 2, 3, 4, 5, 6, 7, 8, 9, 10, 15, 20, 25, 30 or more. Drums/cylinders 200 can be of sufficient number to span the length of hulls 100, 110 with a separation of at least one foot between cylinders in certain embodiments. In one embodiment, drums/cylinders 200 are in groups of 2, 5 or 10 and span the length of hulls 100, 110. The drums/cylinders 200 can be placed such that they are symmetrical across the centerline of the hulls 100, 110.

In one embodiment, the aspect ratio of the drums/cylinders 200 can be varied on the interface of vehicle body and merged medium. Drums/cylinders 200 can span the length from port to starboard or can be ½, ⅓, or ¼ of the width of the hull 100, 110. The thickness of the drums/cylinders may be limited to the area which is in continuous contact at the vehicle-water interface. Preferably the array of drums/cylinders is such that the maintenance may be performed in an optimum manner.

FIG. 1B is a side view of EEH vehicle showing seven drums/cylinders rotationally attached to the flat bottom hull 100. FIG. 1C is a bottom view of the EEH showing the drums/cylinders 200 in a single row in the middle of the hull 100.

FIGS. 1D-F show different views of an embodiment having a chined hull 110 with two rows of drums/cylinders 200 on either side of the hull 110. FIG. 1E shows a bottom view of a hull 110 with two rows of drums/cylinders 200 slightly angled with the interior end pointing to the bow. FIG. 1F illustrates a bottom view of an efficient energy harvesting boat with cylindrical drums and a chined hull, according to an embodiment.

In one embodiment, each individual drum or cylinder 200 is individually rotationally connected to hull 100, 110 so that the drum or cylinder 200 rotates about a horizontal axis parallel to the surface of the water. In a preferred embodiment, drums/cylinders 200 enhance the efficiency of the vehicle by reducing the drag of vehicle at the vehicle-water interface and/or by generating electrical power from the rotational motion of the connected drums/cylinders 200.

In another embodiment, the drums/cylinders are deployable either individually or collectively and are in contact with water when in use. When not in use, the drums/cylinders 200 are withdrawn into the hull of the vehicle and out of contact with the water. In still another embodiment, the rotation of the drums/cylinders is caused by water currents. For example, the bow of the water vehicle can be positioned so that the water current flows from bow to stern causing the drums/cylinders 200 to rotate. The mechanical or rotational energy of the drums/cylinders 200 is converted into electricity. In still another embodiment, the rotation of the drums/cylinders 200 occurs only when the vehicle's propulsion system is not running so that all the energy harvested by the EEH vehicle is from the kinetic energy of the water for example from the movement of the water in a current.

The propulsion system can be a motor connected to a propeller for moving the vehicle along the vehicle-water interface. The motor can be an outboard motor.

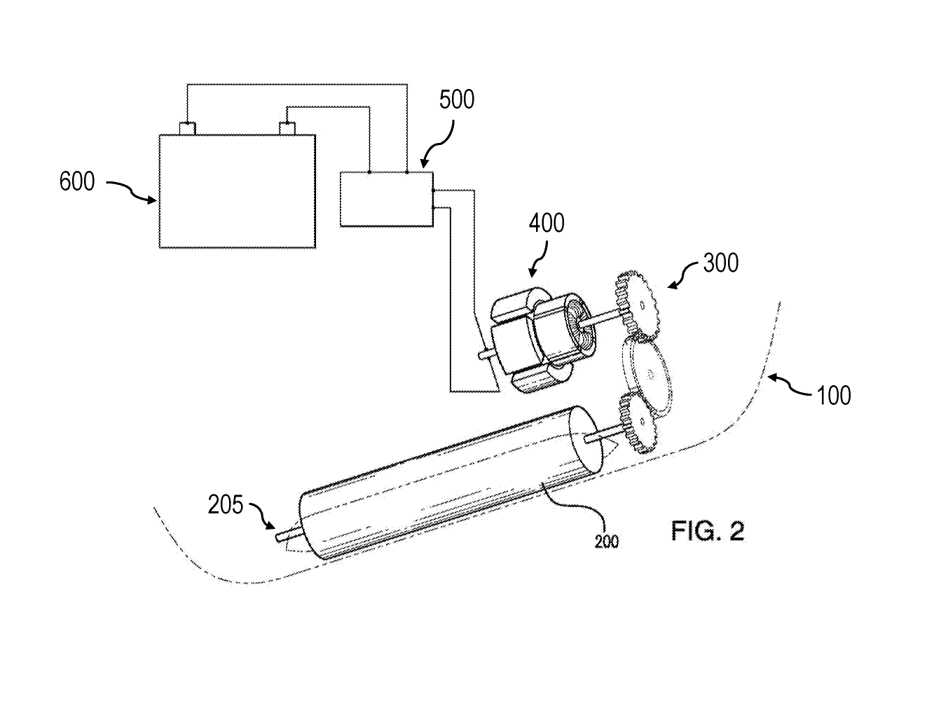

FIG. 2 is a schematic diagram of an exemplary system for harvesting energy from the rotation of the drums/cylinders 200. In one embodiment, drums/cylinders 200 are mechanically coupled to gearbox 300 so that the energy, speed, and torque produced from the rotating drums/cylinders is converted to electricity using electricity producing device 400. The electricity producing device 400 can be a dynamo, alternator, or generator. The dynamo, in an embodiment, contains three major components: the stator, the armature, and the commutator.

The stator is a fixed structure that makes a magnetic field, for example using a permanent magnet. Large dynamos may require an electromagnet. The armature is made of coiled copper windings which rotate inside the magnetic field made by the stator. Gearbox 300 uses the rotation of drums/cylinders 200 to rotate the coiled copper windings of the armature. When the windings move, they cut through the lines of magnetic field and create pulses of electric power. A commutator is needed to produce direct current. In direct current, power flows in only one direction through a wire. The rotating armature in a dynamo reverses current each half turn, so the commutator is a rotary switch that disconnects the power during the reversed current part of the cycle. The wiring of the dynamo can be series wound or shunt wound. The dynamo can be electrically connected to and charge battery 600.

In another embodiment, electricity producing device 400 can be an alternator. The alternator may contain no permanent magnets. Instead, there are two concentric wound coils of wire within the alternator: a stator coil (the outside coil which does not rotate) and a rotor coil (the inside coil, attached to the alternator's pulley, which does rotate). The rotor is also referred to as the alternator's “field.” Gearbox 300 uses the rotation of drums/cylinders 200 to rotate the rotator coil.

An electromagnet is created when current flows through the field coil. The strength of the magnet is directly proportional to the amount of current flowing through the field. As the rotor moves clockwise, the resultant magnetic field sweeps clockwise through the outer coil of wire, and electricity is generated in the stator coil. Since the magnetic field sweeps back and forth through the stator coil, an alternating current is produced. The alternating current has a frequency equal to the frequency with which the alternator's pulley is rotating.

For this process to begin, the alternator's field must start with some kind of current. Rotating the rotor coil itself does absolutely nothing, unless there is current flowing through the coil, producing a magnetic field. Thus, it may be necessary to connect the battery 600 to the alternator to supply this initial current.

Since one purpose of the alternator is specifically to charge batteries including battery 600, the alternating current it produces is rectified through a diode bridge 500. The resulting current is direct current, which can be used to charge an attached battery 600. This dc current can also be used to supply the field coil with current during operation. As a result, the field coil draws current from the battery 600 only until the alternator is capable of producing its own electricity. Once the alternator is producing electricity, it is self-sustaining.

In still another embodiment, electricity producing device 400 can be a generator. The generator can be a small and cylindrical turbine generator with an outer casing made of steel. The mechanical energy needed to make the generator work comes from the rotating force supplied by rotating drums/cylinders 200.

Gearbox 300 translates the rotation of the drums/cylinders 200 to a rotatable rotor that is attached to the turbine shaft. The main job of the rotor is to absorb the mechanical energy outside the generator, and use it to create rotational motion. The turbine shaft will begin to rotate with the rotor, causing all of the inner workings of the machine to rotate as well. Attached to the turbine shaft is a coil of copper wire that rotates at the same speed as the turbine shaft and is often referred to as an armature. On either side of the armature, on the casing of the generator are two polar field magnets that create a magnetic field inside the space within the generator. As the rotor, shaft, and armature rotate, they move within the electric field created by the magnets.

As the turbine rotates the armature through the magnetic field, an electrical current is created within the copper coil of the armature. The faster the copper coil rotates, the more electric current will be created. Finally, the electricity produced can be extracted from the generator. The method of retrieving the electrical energy depends on how it will be used.

Electricity producing device 400 can be electrically coupled to propulsion system and to other electrical devices. Other electrical devices include, but are not limited to, running lights, electric appliances such as refrigerators, radios, computers, navigation equipment, televisions, fans, and combinations thereof.

All references cited herein are incorporated by reference in their entirety. Furthermore, while the foregoing written description of the invention enables one of ordinary skill to make and use what is considered presently to be the best mode thereof, those of ordinary skill will understand and appreciate the existence of alternatives, adaptations, variations, combinations, and equivalents of the specific embodiment, method, and examples herein. Those skilled in the art will appreciate that the within disclosures are exemplary only and that various modifications may be made within the scope of the present invention. In addition, while a particular feature of the teachings may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.”

Other embodiments of the teachings will be apparent to those skilled in the art from consideration of the specification and practice of the teachings disclosed herein. The invention should therefore not be limited by the described embodiment, method, and examples, but by all embodiments and methods within the scope and spirit of the invention. Accordingly, the present invention is not limited to the specific embodiments as illustrated herein, but is only limited by the following claims.

What is claimed is:

1. An apparatus comprising:
a first drum having a first rotational coupling for attachment to a hull of a watercraft and configured to rotate in response to the flow of water around the drum;
a gearbox mechanically coupled to the first drum to transfer rotational mechanical energy from the rotating drums or cylinders to a generator;
wherein the generator receives the rotational mechanical energy from the gearbox and produces electricity.

2. The apparatus of claim 1, wherein the first drum is attached to the hull of the watercraft, and further comprising a second drum having a second rotational coupling and attached to the hull of the watercraft symmetrically to the first drum with respect to the centerline of the watercraft.

3. The apparatus of claim 1, wherein the generator comprises a dynamo, an alternator, or a rotary converter.

4. The apparatus of claim 1, further comprising at least one battery electrically connected to the generator and configured to be charged by the generator.

5. The apparatus of claim 1, wherein the first drum can be drawn into the hull of the watercraft.

6. The apparatus of claim 1, wherein the first drum is cylindrical in shape.

7. The apparatus of claim 1, wherein the first drum is spherical in shape.

8. The apparatus of claim 1, wherein the first drum is pedal shaped.

9. The apparatus of claim 1, wherein the first drum comprises an anti-fouling coating.

10. The apparatus of claim 9, wherein the anti-fouling coating comprises tributyltin.

11. The apparatus of claim 1, wherein the first drum comprises a waterproof polymer coating.

12. The apparatus of claim 1, wherein the generator powers a motor on the watercraft.

13. An efficient energy harvesting (EEH) water or marine vehicle comprising:
a hull coupled to a propulsion system, wherein the hull comprises a plurality of drums or cylinders rotationally coupled to the hull and in contact with water,
wherein the drums or cylinders rotate as the water flows around the drums or cylinders,
wherein the drums or cylinders are mechanically coupled to a gearbox to transfer rotational mechanical energy from the rotating drums or cylinders to a generator, and
wherein the generator receives the rotational mechanical energy from the gearbox and produces electricity from the rotational mechanical energy from the gearbox.

14. The EEH water or marine vehicle of claim 13, wherein the generator is electrically connected to one or more batteries.

15. The EEH water or marine vehicle of claim 14, wherein the generator charges the one or more batteries.

16. The EEH water or marine vehicle of claim 13, wherein the generator provides electricity to a propulsion system.

17. The EEH water or marine vehicle of claim 13, wherein the generator provides electricity to one or more electrical devices.

18. The EEH water or marine vehicle of claim 17, wherein the electrical devices are selected from the group consisting of running lights, refrigerators, radios, computers, navigation equipment, televisions, fans, and combinations thereof.

19. The EEH water or marine vehicle of claim 13, wherein the drums or cylinders are deployable.

20. A method for harvesting energy comprising:
placing a drum attached to the hull of a watercraft in a current, wherein the drum is rotationally coupled to an alternator; and
rotating the drums by the current to cause the mechanical rotation of the drum to rotate a rotor of the alternator.
